(19) United States
(12) Patent Application Publication
(10) Pub. No.: US 2013/0316310 A1
(43) Pub. Date: Nov. 28, 2013

(54) METHODS FOR DETERMINING ORIENTATION OF A MOVING VEHICLE

(71) Applicant: Greenroad Driving Technologies Ltd., Beit-Dagan (IL)

(72) Inventors: Oren MUSICANT, Tel Aviv (IL); Barak SCHILLER, Oxford (GB); Tofig KAREEMOV, Ramle (IL)

(21) Appl. No.: 13/874,552

(22) Filed: May 1, 2013

(30) Foreign Application Priority Data
May 3, 2012 (IL) 219577
Oct. 22, 2012 (IL) 222614

(51) Int. Cl. G01P 15/00; G09B 19/16

(52) U.S. Cl. CPC G01P 15/003; G09B 19/167
USPC 434/65; 702/141

(57) ABSTRACT

A method is provided for determining orientation of a moving vehicle. Using a fixed position device, the method comprises: collecting data which relate to acceleration forces measured along the vehicle axes together with corresponding GPS related information; calculating correlations between measured accelerations and velocity changes and/or vehicle's heading changes; associating the calculated correlations with a plurality of possible yaw rotation angles and derive therefrom a yaw rotation angle that maximizes the correlation; and based on a yaw rotation angle that would maximize the correlation derived, determining the orientation of the moving vehicle. Using a mobile device placed in the vehicle in an unknown position, the method comprises collecting data obtained by the mobile device during a driving session from a GPS and from acceleration measurements made by an accelerometer of the mobile device.

This application claims the benefit under 35 U.S.C. 119 of Israel application 219577, filed May 3, 2012, and Israel application 222614, filed Oct. 22, 2012, the entire contents of which are hereby incorporated by reference for all purposes as if fully set forth herein.

### TECHNICAL FIELD

The present invention relates to determining movement of vehicles and, more particularly, to determining orientation of a moving vehicle.

### BACKGROUND

Vast number of references relate to the use of on-board devices installed in a vehicle that are used to monitor the driver behavior. A major part of these devices are dependent upon the accuracy of the readings of various components comprised therein such as accelerometers or gyroscopes, an accuracy which depends upon the measurement accuracy of the components themselves as well as the accuracy of their installation.

Various approaches have been used in the past for aligning components such as accelerometers. One such approach is manual installation of the sensors in a vehicle, where the manual installation is carried out while ensuring that the axes of the sensors are physically aligned with the longitudinal, lateral, and vertical axes of the vehicle. Another method relies on using known accelerations along the longitudinal, lateral, and vertical axes of the vehicle to enable aligning the accelerometer. However, these methods require skilled installers (usually professional technicians) and are considered to be both expensive and time consuming.

Typically, on-board monitoring devices are located in a fixed position inside the vehicle, each comprising a 2-D or 3-D accelerometer that is used to measure the forces acting on the vehicle. In order to obtain accurate enough data that can be properly used to monitor the driver's performance, it is required for most applications to obtain the acceleration forces with reference to the vehicle, but instead, in current systems these forces are measured with reference to the measuring device itself.

It is therefore required to have a method and device for converting data derived from measuring acceleration forces when the measurements' results are provided with respect to the measuring device itself, to acceleration forces within the vehicle.

In addition, with the vast use of personal mobile wireless devices nowadays, such as cellular smart phones, the use of these devices in various activities which are based on the knowledge of the driver's instantaneous position/movement, has been increasingly adopted by the industry. For example, applications where the driver is prevented from using his phone while being in movement, or certain performance monitoring applications (e.g. determining, based on the time period during which the driver's position was changed from point A to point B, whether the vehicle's speed has been in conformity with the speed limit at that place, etc.),

Still, known applications are rather restricted in their capabilities, as they depend on having the portable wireless device in a fixed position and a fixed orientation (e.g. its cradle), for utilizing the measured data for the respective applications.

In order to be able to provide more meaningful information for more advanced applications, such as monitoring the performance of the driver, driving events carried out by the driver should be identified and evaluated. To do that, it is required to be able to determine the speed and acceleration components for the moving vehicle namely, Vₓ, V_{y}, V_{z} and aₓ, a_{y}, a_{z}, respectively, where x is the direction of the movement of the vehicle, y is the sideway direction and z is the downwards direction. But, in order to determine these components while using a portable wireless device such as the driver's smart phone, one must first overcome the problem of identifying the orientation of a mobile wireless device in order to correlate the forces that are sensed by the portable wireless device with the corresponding actual forces as experienced by the vehicle itself. This is not a simple task when taking into consideration the fact that the mobile wireless device may simply be put on the vehicle seat next to the driver in any unknown orientation, or even may be left in the driver's pocket. Furthermore, even if one determines the smart phone orientation accurately enough before the beginning of a driving session, its orientation and position is likely to shift during the driving session. Thus, no assumption should be made regarding the position and orientation of the mobile wireless device at the time of starting a driving session and during the driving session, in order to run these advanced applications.

The present invention seeks to provide a solution to the above mentioned problems.

### SUMMARY OF THE DISCLOSURE

The disclosure may be summarized by referring to the appended claims.

It is an object of the present invention to provide a method and a software product to enable identifying the orientation of a mobile wireless device placed at an unknown orientation in a vehicle.

It is another object of the present invention to enable converting data measured by a mobile wireless device that had been placed in an unknown position or has moved uncontrollably during driving, into corresponding data that reflect the actual forces as experienced by the vehicle being driven.

It is still another object of the present invention to enable monitoring the driver's performance by measuring data which relate to the driver's performance by using a mobile wireless device (e.g. the driver's smart phone) and applying these measurements in a way that reflects the measured parameters as felt by the vehicle rather than by the mobile wireless device.

It is yet another object of the present invention to provide a method and apparatus for calibrating certain on-board measuring devices installed in a vehicle, so that their measurements will reflect the measured parameters as felt by the vehicle rather than by the measuring device.

It is another object of the present invention to provide a method and apparatus to enable converting results measured by one or more accelerometers into actual accelerating forces acting upon a moving vehicle.

It is yet another object of the present invention to provide a method and apparatus to increase the accuracy of measurements taken for monitoring the performance of the vehicle driver's.

Other objects of the invention will become apparent as the description of the invention proceeds.

According to a first embodiment there is provided a method for determining orientation of a moving vehicle, wherein
I) in case the orientation is determined by a device installed at a fixed position within said moving vehicle, the method comprises the steps of:
   a) collecting data which relate to acceleration forces measured along at least one of the vehicle axes, selected from among the longitudinal (x) axis of the vehicle being driven and the latitudinal (y) axis of the vehicle being driven, together with corresponding GPS related information;
      b) calculating correlations between the measured accelerations and between velocity changes and/or vehicle's heading changes;
      c) associating the calculated correlations with a plurality of possible yaw rotation angles and derive therefrom a yaw rotation angle that would maximize the correlation; and
      d) based on a yaw rotation angle that would maximize the correlation derived, determining the orientation of said moving vehicle; and
   II) in case the orientation is determined by a mobile wireless device placed in said moving vehicle at a non-predefined position (e.g. an arbitrary position) and which comprises at least one accelerometer (e.g. a 3-D accelerometer), the method comprises steps of collecting data obtained by said mobile wireless device during a driving session from a Global Positioning System (GPS) and from acceleration measurements made by the at least one accelerometer of said mobile wireless device.

The term “yaw rotation” as used herein throughout the specification and claims is used to denote a movement around the yaw axis of a vehicle that changes the direction the vehicle in facing, to the left or right of its direction of motion. The yaw rate or yaw velocity of a vehicle is the angular velocity of this rotation. It is commonly measured in degrees per second or radians per second.

The term “mobile wireless device” as used herein and throughout the specification and claims is used to denote a device being a member of the group comprising: a smart phone, a cell phone, a portable wireless communication device, a portable Internet device, a mobile navigation device, a portable digital assistant, a tablet computer, a laptop computer, a personal navigation device, and the like.

The term “driving session” (also known as “driving trip”) as used herein and throughout the specification and claims is used typically to denote a period of time that begins when the driver starts the engine of the vehicle, and ends when the driver turns off the engine of the vehicle. However, it should also be understood to encompass a number of such periods, if say the period of time between each two consecutive driving periods is less than a pre-defined threshold. Typically, each driving session is associated with a plurality of driving events.

According to another embodiment, the method comprises a step of constructing a coordinate system based on the mobile wireless device current position within the vehicle which does not coincide with a Cartesian coordinate system characterizing the movement of the vehicle at which the mobile wireless device is present. Preferably, the mobile wireless device is the center of the coordinate system constructed.

By another embodiment, the method comprising a step of converting data retrieved from acceleration measurements taken by the at least one accelerometer of the mobile wireless device, into data that match the coordinate system characterizing the mobile wireless device.

In accordance with another embodiment, the method provided comprises a step of identifying downwardly direction of the mobile wireless device by detecting one or more constant forces from among the data retrieved from the at least one accelerometer.

According to still another embodiment, the method further comprises a step of identifying isolated driving events based on data retrieved from acceleration measurements made by the at least one accelerometer of the mobile wireless device. The driving events includes: braking, accelerating, turning, zigzags, and vehicle jumps (speed bumps). The term “isolated” used in connection with braking and accelerating events relates to the fact that such an event is not combined with sideways acceleration (either to the left or to the right).

By yet another embodiment, the step of identifying downwardly direction of the mobile wireless device and/or the step of identifying isolated driving events are repeated continuously throughout a driving session to enable updating the coordinate system characterizing the mobile wireless device, accordingly.

According to still another embodiment, the method further comprises monitoring and/or evaluating a driver's driving performance based on data collected by the mobile wireless device associated therewith.

In accordance with another embodiment, the monitoring and/or evaluation of the driver's driving performance is made based upon data associated with at least one driving event identified from among data obtained solely from the mobile wireless device.

By yet another embodiment, the monitoring and/or evaluation of the driver's driving performance is made based upon at least one driving maneuver which comprises a plurality of driving events identified from among data retrieved and/or measured solely from the mobile wireless device.

By still another embodiment, there is provided a method for identifying one or more driving events carried out by a driver of a moving vehicle, wherein the data used for identifying the one or more driving events is based solely on data retrieved and/or measured by a mobile wireless device placed in the moving vehicle at a non pre-defined position.

By yet another embodiment, if the acceleration forces to be measured for the vehicle are measured in the three axes, the method provided further comprises the steps of:

positioning the vehicle on an essentially flat surface (while the vehicle is stationary) and retrieving data derived from the accelerometer device; and

based on the retrieved data, calculating a respective roll angle or a respective pitch angle or respective roll and pitch angles.

In accordance with another embodiment, the method further comprises a step of repeating steps a) to c) for a plurality of driving sessions, and averaging the results thus obtained over time, thereby obtaining an updated estimation for the yaw rotation angle.

In accordance with yet another embodiment, at least one of the driving events retrieved in a process of monitoring performance of a specific vehicle's driver, is associated with information allowing comparison between that at least one driving event and information associated with a corresponding driving event signature, and the method provided further comprises adjusting the conversion matrix associated with the specific driver's vehicle if the difference between parameters associated with the at least one driving event and parameters associated at least one corresponding driving event signature, exceeds a predefined threshold.

The term “a corresponding driving event signature” as used herein throughout the specification and claims is used to denote either a case where the driving event characteristics relate to the average of parameters associated with a specific driving event (e.g. braking), and wherein the driving event signature is calculated based on a plurality of such specific driving events, all of which carried by a specific driver. In the alternative, the driving event signature relates to the most likely parameters values associated with a specific driving event, and wherein the driving event signature is calculated based on a plurality of such specific driving events carried by a plurality of drivers. For example, averaging the parameters associated with a braking event, obtained while monitoring the driving performance of many drivers and calculating the average parameters retrieved while carrying out that braking event.

According to still another embodiment, the method provided further comprises a step of transmitting the calculated conversion matrix from a plurality of vehicles to a central information entity (e.g. a server), and providing modification information which relates to the conversion matrix, to at least one of the plurality of vehicles.

According to another aspect, a monitoring arrangement (e.g. an on-board apparatus) is provided for determining a value of an event performance variable associated with a driving event, the monitoring arrangement comprises:
means configured to retrieve information from a GPS receiver;
means configured to retrieve information from one or more accelerometers (a “multi-axis” accelerometer may be used, which is capable of monitoring multiple independent vector accelerations along more than a single axis);
at least one processor configured to:
collect data which relate to acceleration forces measured along at least one of the vehicle axes, selected from among the longitudinal (x) axis of the vehicle being driven and the latitudinal (y) axis of the vehicle being driven, together with corresponding GPS related information;
calculate correlations between the measured accelerations and velocity changes and/or vehicle's heading changes;
associate the calculated correlations with a plurality of possible yaw rotation angles and derive therefrom a yaw rotation angle that would maximize the correlation; and
based on a yaw rotation angle that would maximize the correlation derived, calculate a conversion matrix to enable converting data that would be obtained while measuring acceleration forces, to acceleration forces that reflect actual forces experienced by the vehicle.

By yet another embodiment, if the monitoring arrangement comprises means configured to retrieve acceleration forces that would be measured at three axes of the vehicle, the at least one processor is further adapted to:

collect data retrieved from the means configured to retrieve acceleration forces after having positioned the vehicle on an essentially flat surface; and

calculate a respective roll angle, or a respective pitch angle or respective roll and pitch angles based on the retrieved data.

According to still another embodiment, the at least one processor is adapted to collect data which relate to acceleration forces measured along the longitudinal (x) axis of the vehicle being driven, together with corresponding GPS related information for each of a plurality of driving sessions, to calculate correlations between the measured acceleration forces and velocity changes for each of these driving sessions, and to update the conversion matrix based on the yaw rotation angle calculated for a respective session that would maximize the correlation derived, thereby obtaining an updated conversion matrix. By applying the above embodiment, it is possible to check every driving session whether an update of the conversion matrix is required, and if so, to preferably carry out that update (modification).

In accordance with yet another embodiment, at least one of the driving events retrieved in a process of monitoring performance of a specific vehicle's driver is associated with information that enables comparing that at least one driving event with information associated with a corresponding driving event signature, and the at least one processor is further configured to adjust the conversion matrix of the monitoring arrangement installed in the specific driver's vehicle if the difference between parameters associated with the at least one driving event and parameters associated at least one corresponding driving event signature, exceeds a predefined threshold. This embodiment is useful for example to enable restarting the calibration process.

By yet another embodiment the monitoring arrangement further comprises at least one additional sensor adapted to collect data that relates to monitoring a driver's performance based on driving events carried during a driving session of a vehicle. The data collected from such a sensor are not orientation dependent and as such may be useful for monitoring purposes. Such additional sensors may be for example a tachometer, braking pressure indicator, accelerator pressure indicator, steering wheel control, handbrake, turn signals, vehicle location, vehicle velocity and transmission or gearbox control.

In accordance with another aspect there is provided a system which comprises a plurality of monitoring arrangements described herein, each of which further comprising a transmitter configured to transmit the respective calculated conversion matrix;

at least one central information entity (e.g. a server) operative to receive the calculated conversion matrix from each of the plurality of monitoring arrangements, and to provide to at least one of the plurality of monitoring arrangements information to enable modifying the conversion matrix associated with the respective at least one monitoring arrangements, where the modification information is based upon data received (e.g. the conversion matrix) from the plurality of monitoring arrangements.

According to another aspect of the invention there is provided a computer program product encoding a computer program stored on a non-transitory computer readable storage medium for executing a set of instructions by a computer system comprising one or more computer processors, for carrying out a method as described hereinabove.

### BRIEF DESCRIPTION OF THE DRAWINGS

For a more complete understanding of the present invention, reference is now made to the following detailed 10 description taken in conjunction with the accompanying drawings wherein:

FIG. 1A to 1C—illustrate various aspects of coordinates systems used for carrying out embodiments of the present invention;

FIG. 2—presents a flow chart demonstrating an optional way of implementing the present invention; and

FIG. 3—presents a flow chart demonstrating an optional way of implementing an embodiment of the present invention.

FIG. 4—illustrates the various axes along which the calibration process provided by the present invention may be carried out; and

FIG. 5A to 5D—present a number of flow charts demonstrating optional ways of implementing the present invention, wherein;

FIG. 5A—presents an initial calibration process;

FIG. 5B—presents a modification process carried out by the in-vehicle apparatus;

FIG. 5C—presents a modification process carried out by a central entity; and

FIG. 5D—presents another embodiment of a modification process carried out by a central entity.

### DETAILED DESCRIPTION

In this disclosure, the term “comprising” is intended to have an open-ended meaning so that when a first element is stated as comprising a second element, the first element may also include one or more other elements that are not necessarily identified or described herein, or recited in the claims.

In the following description, for the purposes of explanation, numerous specific details are set forth in order to provide a thorough understanding of the present invention. It should be apparent, however, that the present invention may be practiced without these specific details.

### Determining Vehicle Orientation by a Mobile Device

Let us begin with a case in which the orientation is determined by a mobile wireless device placed in a moving vehicle at an unknown position.

As explained hereinabove, one of the objects of the present invention is to provide a method to enable identifying the orientation of a mobile wireless device relative to the vehicle at which it is placed. Once the orientation of the mobile wireless device has been determined, the forces of acceleration may be aligned and then may be classified into several classes such as forward/backward acceleration (X axis) and sideways acceleration (Y axis). Another result is that the force of gravity may be removed from the acceleration 25 measurements.

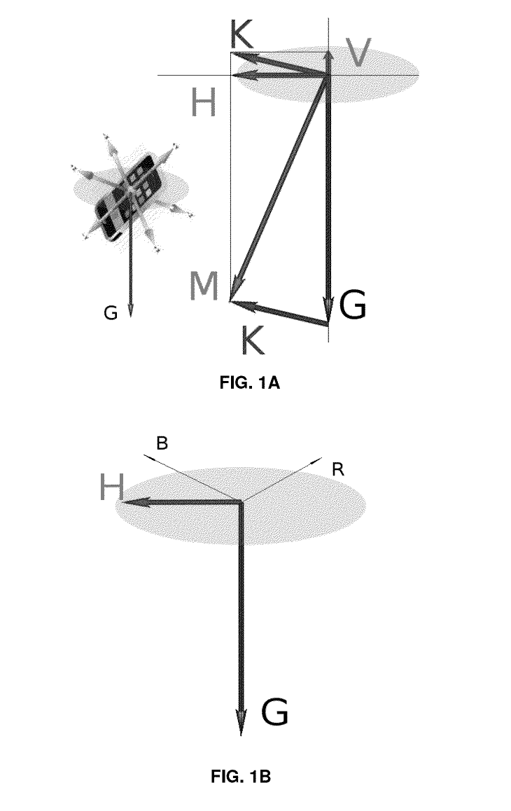

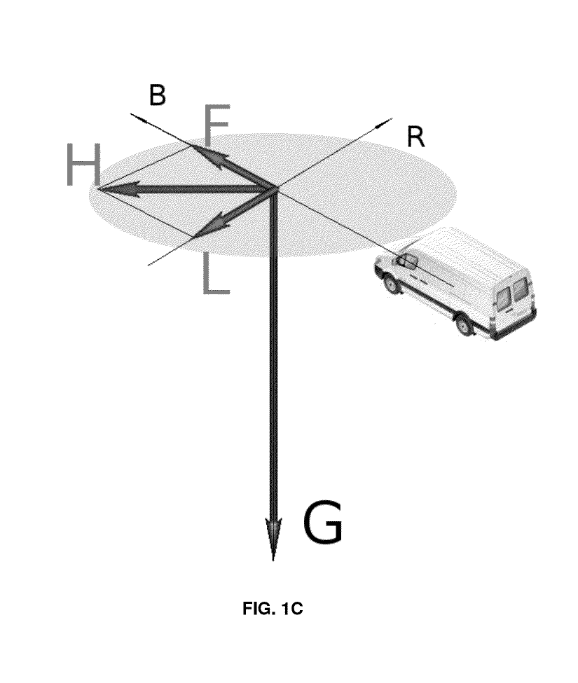

FIG. 1A to 1C illustrate various aspects of coordinates systems used while carrying out embodiments of the present invention, in which X, Y, Z—are the axis of an accelerometer coordinate system, and wherein the following forces are demonstrated:

G—Gravity vector;
M—Measurement vector;
K—Kinematic force vector;
H—Horizontal component of vector K;
V—Vertical component of vector K;
F—Frontal component of vector H;
L(-R)—Left side component of vector H;
B—Vehicle bearing axis
R—Vehicle right side axis
F(-F) and R(-R) are vectors that are entering Vehicle Signature Profile (“VSP”) based Event Detection Mechanism.

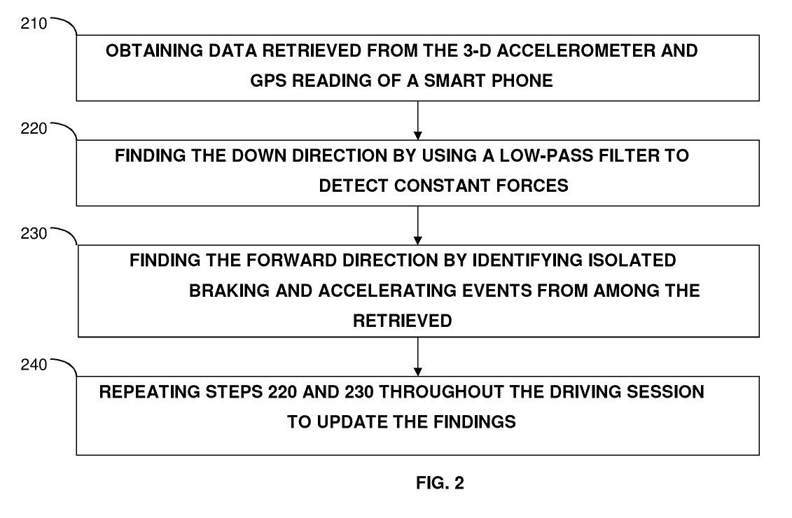

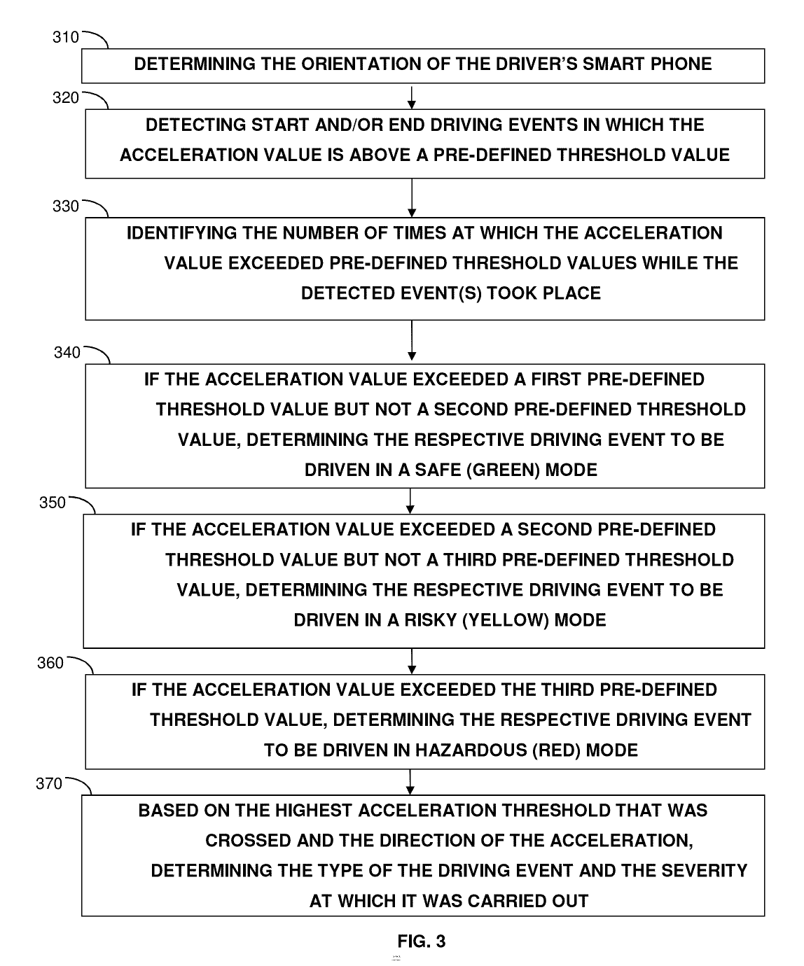

According to an embodiment of the solution provided demonstrated in FIG. 2, data is obtained from one or more 3-D 10 accelerometers of the wireless mobile device (e.g. a 3-D accelerometer) and GPS reading are retrieved (where each one of the three axis is subjected to a force acting thereupon) (step 210), and based on the data being retrieved, the following steps are carried out:
Finding the “down” direction by using a low-pass filter to detect “constant” forces. These constant forces are assumed to be the force of gravity and hence point downwardly (step 220);
Finding the “forward” direction by identifying isolated braking and accelerating events from among the data retrieved (step 230); and
Repeating both steps continuously throughout the driving session to enable updating the above findings (step 240).

In order to enable dynamic learning of gravitational force G, a high-pass filter is applied using exponential smoothing mechanism or Length Limited Average algorithm onto the measured acceleration data in order to detect and remove the force of gravity from the measurements' data.

The smoothing of the gravity vector was done by applying a parameter α, that expresses how fast does the gravity vector change, where higher values of α, result in a slower learning process. As part of this calculation and in order to remove the force of gravity from the measured data, the following relationship is used

$${y}_{n + 1} = ( 1 - \frac{1}{α} ) * {y}_{n} + \frac{1}{α} * {x}_{n}$$

### Where:

yₙ is a portion of the acceleration attributed to gravity; and
xₙ is the raw data of the measured acceleration

As gravity changes are less likely to occur while driving at high speed, the value of a in the above formula may be dynamically adjusted according to the vehicle's speed.

The adjustment of a may be carried out according to the following:

$$α = LimitMin + ( LimitMax - LimitMin ) * \frac{speed}{SpeedMax}$$

wherein:
LimitMin is the minimum allowable value for α;
LimitMax is the maximum allowable value for α; and
SpeedMax is a value set for the maximum speed.

These three parameters namely, LimitMin, LimitMax and SpeedMax are preferably configurable parameters.

In other words, the value of a may change within the range extending from LimitMin to LimitMax according to the vehicle speed, whereas any speed of the vehicle that exceeds the value SpeedMax, may be considered as being equal to SpeedMax. Lower speed will result in a lower a (and thus faster learning) while high speeds will result in a higher a (and consequently slower learning). If the speed is not available, a may simply be set to a constant value.

As will be appreciated by those skilled in the art, this mechanism may be disabled by setting a respective pre-determined value for each of the two parameters LimitMin and LimitMax. When using Length Limited Average algorithm the parameter a increases until it reaches its defined value.

Once the vector G has been determined, vector A(x,y,z), being the acceleration vector in the system may be determined based on the accelerometer measurements.

Based on the relationship of:

K=A−G

vector K which represents the kinematic force applied onto the vehicle, may be derived.

Next, upon projecting vector K onto vector G, vector V is obtained, and upon projecting vector K onto a plane that is perpendicular to vector G, vector H is obtained. Vector H may then be used in indicate the severity of the maneuvers that are carried out by the driver. The higher the magnitude of vector H is, the more severe is the maneuver that was carried out by the driver.

In order to evaluate the driver's driving performance during a certain driving event, a time window may be selected, and the values of x, y and z components of vector H are averaged for the duration of that time window. If the averaged values of the components of vector H are less than a predetermined value, another time window is selected.

Next, the GPS readings provide information regarding the location of the vehicle, its speed and its bearing. Let us assume that there had been a driving event during the period of time encompassed by the time window. From the GPS readings it is possible to calculate the vehicle speed before the driving event has begun, the vehicle speed at the end of the driving event and the change in the vehicle speed during the driving event. A similar exercise may be carried out for the orientation of the vehicle by calculating the vehicle's bearing before the driving event has begun, the vehicle's 30 bearing at the end of the driving event and the change in the vehicle bearing during the driving event.

Now, assuming that vector H is equal to a vector designated as “B”, and as the vertical vector Z is known, a vector product of Z×B will yield vector R pointing to the vehicle's right. This provides us with a new coordinate system which is independent of the orientation at which the mobile wireless device was placed in the vehicle, and the components of vector K may be projected onto axes B, R and G.

Preferably, during the driving session the value of vector G is measured and calculated periodically or continuously, as the case may be, and if there is a change of vector G as sensed by the mobile wireless device, based on that change the other axes are corrected respectively. In addition or in the alternative, it is possible to establish whether there is a change of vector G that may be sensed by the mobile wireless device, is by activating a camera device incorporated in the mobile device and determine whether there is a change in the image as compared with one or more preceding images.

The method described in the above example relies the fact that even though the location and the orientation of the mobile wireless device such as a cellular telephone in the vehicle is not known at the time the driving session begins, still by applying this method while identifying that certain events took place, it is possible to calibrate the system in a way that will provide reliable enough data to evaluate therefrom in an accurate way for example the performance of the driver during the driving session. As will be appreciated by those skilled in the art, the driving events which are identified during the calibration process need not to be poorly performed driving events (having more distinct characteristics) but also driving events that were well performed may be used for that purpose.

Still, it should be noted that the above described procedure for finding the forward direction may require a few acceleration and brakes to accurately lock on the correct direction (typically about 5 minutes of driving, depending on driving conditions).

According to another embodiment, the mobile wireless device which has been placed in the vehicle being driven by the driver is used to determine the driver's performance. The following example demonstrates one way of determining the quality of the driving while carrying out acceleration-based driving events by detecting, identifying and quantifying these driving events.

After having established the orientation of the driver's mobile wireless device in a way described above (step 310), the readings made by the accelerometer (preferably but not necessarily by a 3-D accelerometer) may be used in the following steps:

(1) Detecting start and/or end driving event(s) in which the acceleration value is above a pre-defined threshold value (step 320);
(ii) During the period at which the detected driving event took place, identifying the instances at which the acceleration value has exceeded a pre-defined threshold value. Preferably there are three pre-defined threshold values (step 330). When the acceleration value measured for the driver exceeds the first one but not the second one, it means that an acceleration based event is taking place but the driver is driving in a safe mode (green mode) (step 340). If the acceleration value exceeds the second threshold but not the third threshold, that means that the driver is carrying out that part of the driving event in a risky mode (yellow mode) (step 350), and if the acceleration value exceeds the third threshold, that part of the driving event has been carried out hazardously (red mode) (step 360). For example, a severe braking event can take the form of: Start (no acc.)+Brake green yellow→red→yellow→green→End (no acc.).
(iii) At the end of the event, the maximal acceleration threshold that was crossed is used together with the direction of the acceleration, in order to determine the event type and the severity at which it was carried out by the driver (step 370).

As may be appreciated by those skilled in the art, the method provided is able to detect more complex events by detecting the maximal thresholds crossed at each one of at least two of the three axes.

The following non-limiting example relates to another example in which the driving events/maneuvers are identified through the recognition of their pattern by using transitions of a state machine, according to an embodiment of the present invention. In this example, the state machine examines each driving event in the input event data string, and traverses a tree with leaf nodes corresponding to recognized driving events (e.g. a tree provided by a library database). The method starts by declaring an event start/end when the measured acceleration value exceeds a pre-defined threshold. Next, the type of the driving event is identified by “walking” on the leaf nodes of the tree based on the maximal acceleration value that has been measured so far.

Once a leaf node is reached in the tree, an event is detected. The severity of the event is determined based on the combination of the magnitude of the maximal acceleration as measured in on both axes, e.g. by (\sqrt{x²+y²})

The method can be implemented by applying threshold values that are set for each leaf node separately from the others.

### Determining Vehicle Orientation by a Fixed Device

Let us turn to a case in which the orientation is determined by case the orientation is determined by a device installed at a fixed position within a moving vehicle.

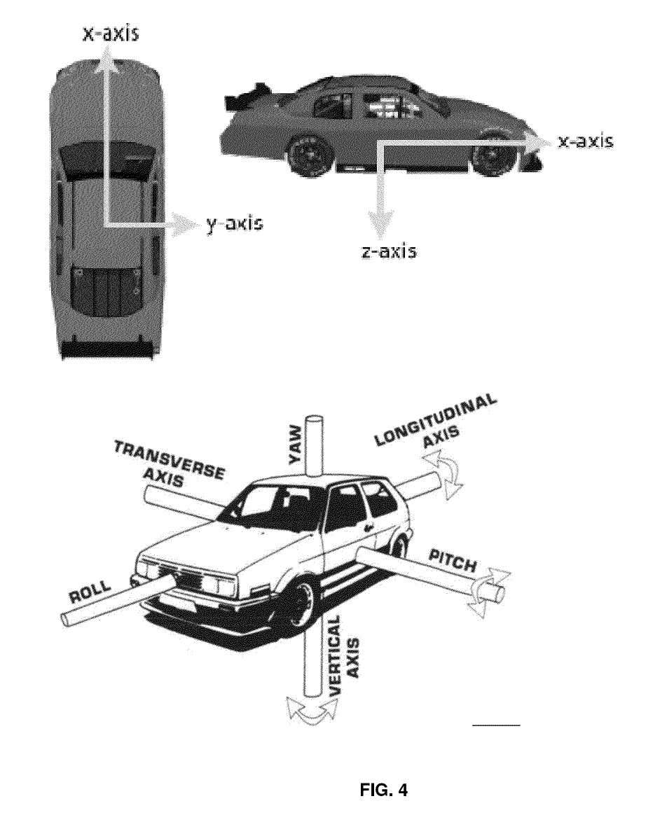

FIG. 4 presents the various axes associated with a vehicle and the three possible rotations, namely yaw, roll and pitch, thereof.

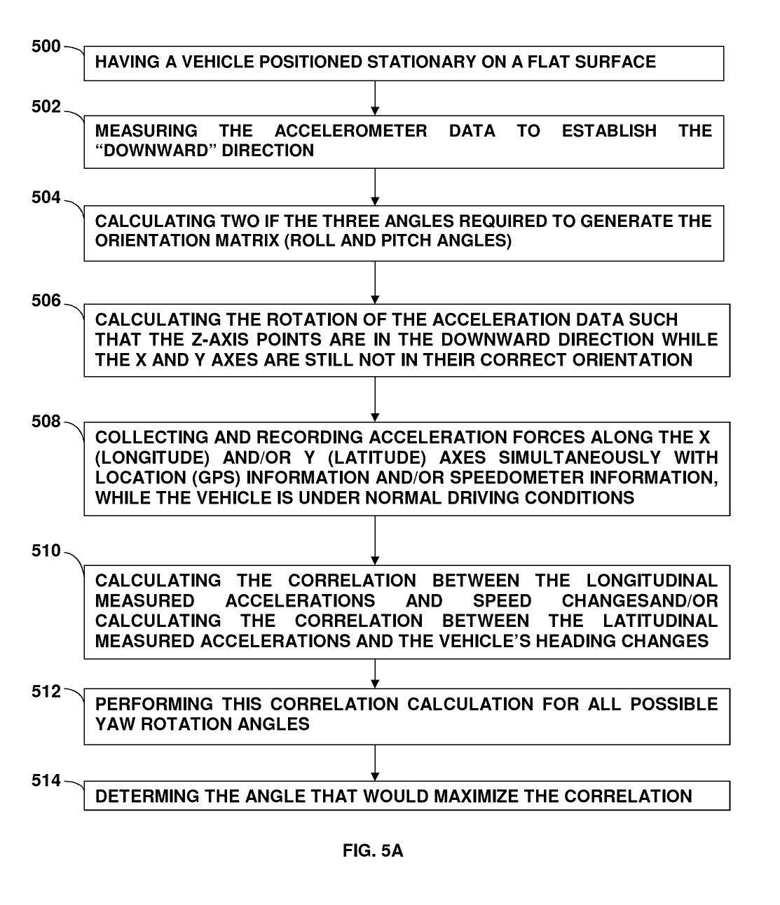

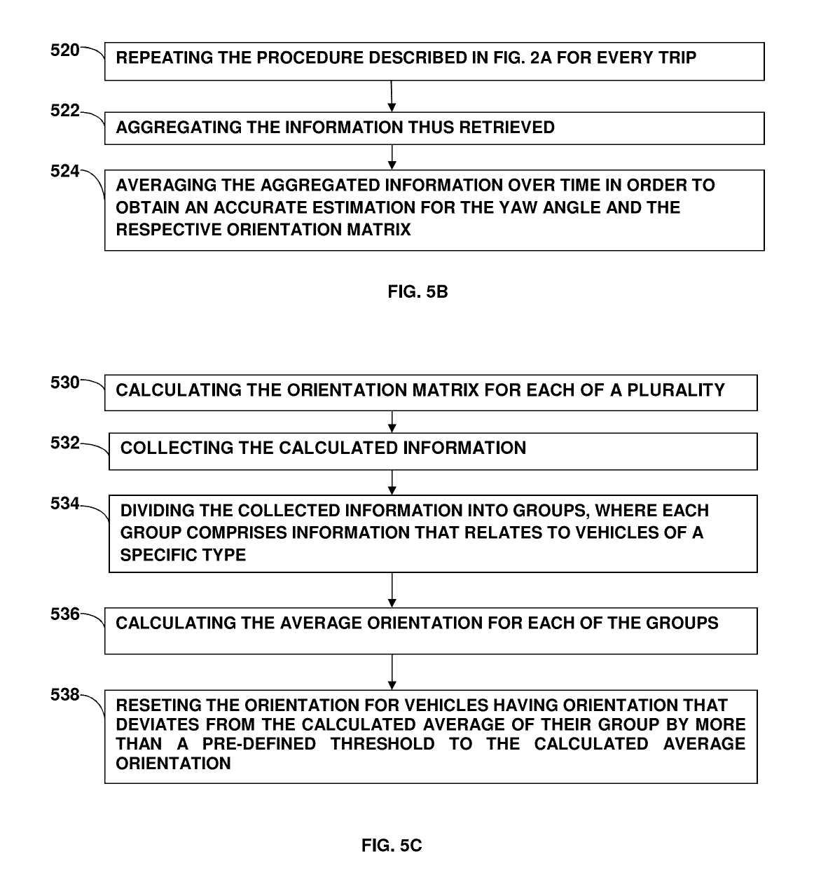

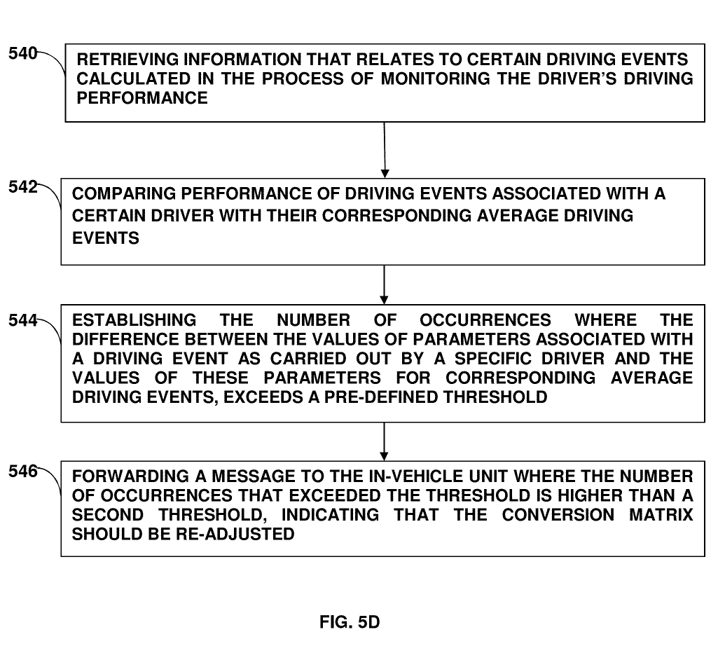

FIG. 5A exemplifies an initial calibration phase in order to properly align an in-vehicle device such as a system for monitoring the driver's performance, and the like, that requires for its operation a relatively high accuracy in determining the acceleration forces affecting the vehicle.

If the in-vehicle unit comprises a 3-D accelerometer, the initial calibration process begins when the vehicle is positioned stationary on a flat surface (step 500), and the device measures the accelerometer data to establish the “downward” direction (step 502). Because the vehicle is stationary, the only force acting upon the device is the force of gravity and this assumption is used for calculating two of the three angles (step 504) required to generate the orientation matrix (roll and pitch angles). At the end of this phase the conversion matrix (also referred to herein as the “orientation matrix”) can be applied for calculating the rotation of the acceleration data such that the Z-axis points are in the downward direction while the X and Y axes are still not in their correct orientation (step 506).

However, if the in-vehicle unit comprises a 2-D accelerometer, steps 500 to 506 are replaced by manual calibration of the unit which is installed in parallel to the 25 ground but with no restriction on the yaw angle.

The next phase of the initial calibration process is performed when the vehicle is under normal driving conditions. During the driving session (the trip), the device is used to collect and record acceleration forces along the X (longitude) 30 and/or Y (latitude) axes simultaneously with location (GPS) information and/or speedometer information (step 508). The in-vehicle unit keeps calculating the correlation between the longitudinal measured accelerations and speed changes (step 510) and/or the correlation between the latitudinal measured accelerations and vehicle's heading changes (step 512), and performs this correlation calculation for all possible yaw rotation angles (step 512) in order to determine the angle that would maximize the correlation (step 514).

As explained herein, the measurement of the accelerations during this phase in order to eventually determine the yaw rotation angle can preferably be along one of the axes X or Y. When the measurements are done along the X-axis, they are correlated with speed changes of the vehicle in order to accurately determine the yaw rotation angle needed to complete the orientation matrix. In the alternative, when the measurements are done along the Y-axis, they are correlated with the heading changes of the vehicle in order to accurately determine the yaw rotation angle needed to complete the orientation matrix. Obviously, it is possible to determine the yaw rotation angle after carrying the acceleration measurements along both X and Y axes.

FIG. 5B presents a flow chart of a modification process carried out by the in-vehicle unit.

Assuming that the in-vehicle unit has not been since its installation and the initial calibration process as described hereinabove, hence its orientation with respect to the vehicle remains constant. Still, it may be required to fine-tune the orientation matrix. In order to do that, the in-vehicle unit 25 keeps performing the aforementioned procedure for driving orientation on each subsequent trip (step 520). The information is aggregated (step 522) and is averaged over time (step 524) to get an even more accurate estimation for the yaw angle and the respective orientation matrix.

FIG. 5C relates to a modification process for the orientation matrix carried out by a central entity. According to one embodiment this process is done by following the process presented in the flow chart present in FIG. 5C. Typically, the way that an in-vehicle unit is installed in a specific vehicle is the same as for all other vehicles that belong to the same type (e.g. buses, trucks, small cars, etc). This fact allows relying on the assumption that the orientation procedure described above provides similar (up to about 5°) yaw rotation angles for all vehicles belonging to the same type of vehicle. The modification process presented in FIG. 5C comprises the steps of: calculating orientation matrix for each of a plurality of vehicles (step 530), at a central server, collecting information that relates to the calculated orientation matrixes (step 532). Dividing the collected information into groups where each group comprises information that relates to vehicles that belong to a specific type of vehicle (step 534). Next, for each of the groups, the average orientation is calculated (step 536) and those vehicles having orientation that deviates from the average orientation of the group to which they belong by more than a pre-defined threshold are reset (step 538) by a command sent to them from the central server, so that the orientation of such in-vehicle units will be equal to the calculated average orientation.

FIG. 5D presents a flow chart of another embodiment for carrying out a modification process of in-vehicle unit's orientation matrix by using a central entity. According to this embodiment, each in-vehicle unit retrieves information (step 540) that relates to certain driving events which were calculated in the process of monitoring the performance of a specific driver. This retrieved information is associated with information that would allow comparing certain driving events with their corresponding driving events' signatures stored at the central entity. Preferably, the driving events that are used in this embodiment are pre-defined driving events, from among the various events using in determining the driver's performance, such as braking, turning and accelerating, which are transmitted from the plurality of the in-vehicle units to the central entity along with additional information. This additional information comprises certain parameters which can be for example vehicle's speed at the beginning, end and along the driving events, the driving event duration, acceleration variability, GPS heading changes and the like. The driving events associated with a certain driver are then compared by the central entity with their corresponding driving events' signatures (step 542) in order to establish the number of occurrences where difference between parameters associated with the various driving events as carried by the specific driver and parameters associated with the corresponding driving events' signatures, exceeds a predefined threshold (step 544). For those in-vehicle units that it has been established that the number of occurrences where the difference exceeds the predefined threshold is higher than a second threshold, the central entity conveys a message (step 246) to each respective in-vehicle unit, indicating that the conversion matrix associated therewith should be adjusted. Preferably, this message also provides the in-vehicle unit with an indication as to the magnitude of the offset to be adjusted, e.g. to adjust the orientation matrix to the values of the average orientation matrix of the type of vehicle which is driven by the specific driver.

The present invention has been described using detailed descriptions of embodiments thereof that are provided by way of example and are not intended to limit the scope of the invention in any way. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

What is claimed is:

1. A method for determining orientation of a moving vehicle, wherein
in case the orientation is determined by a device installed at a fixed position within said moving vehicle, the method comprises:
collecting data which relate to acceleration forces measured along at least one of the vehicle axes, selected from among the longitudinal (x) axis of the vehicle being driven and the latitudinal (y) axis of the vehicle being driven, together with corresponding GPS related information;
calculating correlations between the measured accelerations and velocity changes and/or vehicle's heading changes;
associating the calculated correlations with a plurality of possible yaw rotation angles and derive therefrom a yaw rotation angle that would maximize the correlation; and
based on a yaw rotation angle that would maximize the correlation derived, determining the orientation of said moving vehicle;
in case the orientation is determined by a mobile wireless device placed in said moving vehicle at a non-predefined position, and which comprises at least one accelerometer, the method comprises collecting data obtained by said mobile wireless device during a driving session from a Global Positioning System (GPS) and from acceleration measurements made by the at least one accelerometer of said mobile wireless device.

2. The method of claim 1, wherein in case the orientation is determined by said mobile wireless device, the method comprises constructing a coordinate system based on the mobile wireless device current position within the vehicle which does not coincide with a Cartesian coordinate system characterizing the movement of the vehicle at which the mobile wireless device is placed.

3. The method of claim 2, further comprising converting data retrieved from acceleration measurements taken by the at least one accelerometer of the mobile wireless device, into data that match the coordinate system characterizing the mobile wireless device.

4. The method of claim 2, comprising identifying a downwardly direction of said mobile wireless device by detecting data that relates to one or more constant forces from among data retrieved from acceleration measurements taken by the at least one accelerometer of the mobile wireless device.

5. The method of claim 2, comprising identifying braking and accelerating driving events based on data retrieved from the acceleration measurements made by the at least one accelerometer of the mobile wireless device.

6. The method of claim 4, wherein identifying downwardly direction of said mobile wireless device is repeated continuously throughout a driving session to enable updating the coordinate system characterizing the mobile wireless device, accordingly.

7. A method for monitoring and/or evaluating a driver's driving performance based on retrieving the orientation of the moving vehicle from said mobile wireless device determined according to claim 1, and wherein the data collected by the mobile wireless device is associated with said driver.

8. The method of claim 7, wherein the monitoring and/or evaluation of the driver's driving performance is made based 5 upon data associated with at least one driving event identified from among data retrieved solely from the mobile wireless device.

9. The method of claim 8, wherein the monitoring and/or evaluation of the driver's driving performance is made based upon at least one driving maneuver which comprises a plurality of driving events identified from among data retrieved solely from the mobile wireless device.

10. A method for identifying one or more driving events carried out by a driver of a moving vehicle, wherein the data used for identifying the one or more driving events is based solely on data obtained by a mobile wireless device placed in the moving vehicle at a non pre-defined position.

11. The method according to claim 1 wherein the orientation is determined by a device installed at a fixed position within said moving vehicle, if the acceleration forces to be measured for the moving vehicle by said device 25 would be measured at three axes, the method further comprises:
positioning the vehicle on an essentially flat surface and retrieving data derived from the accelerometer device; and
based on the retrieved data, calculating a respective roll angle or a respective pitch angle or respective roll and pitch angles.

12. The method according to claim 1 wherein the orientation is determined by a device installed at a fixed position within said moving vehicle, said method further comprising repeating the calculating, associating and determining for a plurality of driving sessions, and averaging the results thus obtained over time, thereby obtaining an updated estimation for the yaw rotation angle.

13. The method according to claim 1 wherein the orientation is determined by a device installed at a fixed position within said moving vehicle, wherein at least one driving event retrieved in a process of monitoring performance of a specific driver, is associated with information that allow comparison between said at least one driving event and information associated with a corresponding driving event signature, and wherein the method further comprises adjusting the conversion matrix associated with the specific driver's vehicle if the difference between parameters associated with the at least one driving event and parameters associated at least one corresponding driving event signature, exceeds a predefined threshold.

14. The method according to claim 1 wherein the orientation is determined by a device installed at a fixed position within said moving vehicle, said method further comprising transmitting the calculated conversion matrix from a plurality of vehicles to a central information entity, and providing modification information which relates to the conversion matrix, to at least one of the plurality of vehicles.

15. A computer program product encoding a computer 30 program stored on a non-transitory computer readable storage medium for executing a set of instructions by a mobile wireless device comprising one or more computer processors, for carrying out the method of claim 1.

16. The computer program product of claim 15, wherein in case the orientation is determined by said mobile wireless device, the method comprises enabling constructing a dynamically updateable coordinate system based on the mobile wireless device current position within the vehicle which does not coincide with a Cartesian coordinate system characterizing the movement of the vehicle at which the mobile wireless device is placed.

17. The computer program product of claim 16, wherein the method further comprising converting data retrieved from acceleration measurements taken by the at least one accelerometer of the mobile wireless device, into data that match the coordinate system characterizing the mobile wireless device.

18. The computer program product of claim 16, wherein the method further comprising identifying downwardly direction of said mobile wireless device by detecting data that relates to one or more constant forces from among data retrieved from acceleration measurements taken by the at least one accelerometer of the mobile wireless device.

19. The computer program product of claim 16, wherein the method further comprising identifying braking and accelerating driving events based on data retrieved from the acceleration measurements made by the at least one accelerometer of the mobile wireless device.

20. The computer program product of claim 15, wherein in case the orientation is determined by said mobile wireless device and wherein the method further comprising monitoring and/or evaluating a driver's driving performance based on data collected by the mobile wireless device associated with said driver.
